(19) United States
(12) Patent Application Publication
(10) Pub. No.: US 2010/0058441 A1
(43) Pub. Date: Mar. 4, 2010

(54) Information processing limitation system and information processing limitation device

(75) Inventors: Hiromi Isokawa, Sagamihara (JP); Makoto Kayashima, Yokohama (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi Ltd., Chiyoda-ku, Tokyo (JP)

(21) Appl. No.: 12/310,624

(22) PCT Filed: Feb. 17, 2009
(86) PCT No.: PCT/JP2009/000635

§ 371 Date: Mar. 2, 2009

(30) Foreign Application Priority Data
Mar. 27, 2008 (JP) 2008-082482
Oct. 28, 2008 (JP) 2008-276785

(51) Int. Cl. G06F 21/00

(52) U.S. Cl. 726/3

(57) ABSTRACT

This information processing limitation system includes an information processing server computer 103 which provides an information processing service, and a terminal computer 101 which is coupled to the information processing server computer 103 and utilizes that information processing service. The terminal computer 101, when utilizing the information processing service, limits the utilization of the information processing service on the basis of a security state which is required for the utilization of the information processing service.

### TECHNICAL FIELD

The present invention generally relates to a technique for limiting the information processing function provided by an information processing device (hereinafter termed a “computer”), and in particular relates to a technique for limiting the information processing function according to the state of the computer.

### BACKGROUND ART

In recent years, due to the rapid development of network society, the security of networks has become a great problem. One problem regarding network management and information management in an organization might be the bringing in of notebook computers and the use of corrupted software. By a notebook personal computer which has become infected with a computer virus outside an organization, for example at home or in a branch office or the like, being connected to a network within the organization, the problem has arisen of spreading of computer viruses, which may cause damage which can bring the network down, or the like. Moreover examples have also occurred of information which is secret to an organization becoming intentionally or inadvertently disclosed to the outer, i.e. of leakage of information, due to software whose usage is prohibited (forbidden software) being used within the organization. In the prior art, in order effectively to stop this type of damage, in addition to the implementation of countermeasures on the network level such as firewalls and intrusion detection systems and the like, security strengthening has been implemented in order to prevent information leakage due to computers (hereinafter termed “terminals”) which are utilized by users.

One security strengthening measure might be a quarantine system which limits communication via a network within the organization, performed by a terminal whose computer virus countermeasure includes some defects or upon which forbidden software is installed. The objective of such a quarantine system is not to allow a terminal to connect to the network if it does not conform to the policy of the organization (i.e. rules relating to the state of the terminal which must be obeyed, such as that computer virus countermeasure software is running, that the newest bug fixed have been implemented, that the terminal is registered, and so on); and such a quarantine system may include a combination of functions like the following (1) through (3):

(1) A testing function: this is a function of testing whether the state of a terminal is one which conforms to a policy;
(2) An isolating function: this is a function of making it impossible for a terminal which does not conform to a policy to connect to the network, or only allowing it to connect to some specified network;
(3) A treatment function: this is a function of performing bug fixing upon the terminal or change of its configurations, so that it conforms to the policy.

For example, a technique is disclosed of limiting access to a network from a terminal if computer virus countermeasure includes some defects (refer to Patent Citation 1). With this quarantine system, it is possible to check the state of a terminal before it is connected to a network within an organization, and accordingly it is possible to prevent an influence upon other computers which are connected to the organization network, or upon the network itself, which might be occurred as a result of lack of security on this terminal.

Moreover, as a measure for preventing information leakage from terminals and thereby strengthening security, centralized type information processing systems are also being implemented which anticipate prevention of information leakage from terminals and reduction of the cost of managing terminals, by collecting the information upon the terminals, and their information processing functions, into an information center which is located within the same organization or at a trusted destination, and by using this collected information and these collected information processing functions from remotely. For example, in Patent Citation 2, a method is disclosed of enhancing security when a user is using a terminal, by sending the information which is inputted by the user at the terminal via a keyboard or a mouse or the like to a computer in the information center, and by this computer in the information center performing processing according to this user input and sending only the resulting screen information or audio information back to the user at the terminal; and thereby it becomes possible to perform information processing without sending the information itself to the terminal. For example, by distributing anti-tamper devices to the users, and by the users accessing a remote computer via the network using authentication information within these anti-tamper devices and performing remote control, it is possible to reduce the amount of secret information which remains within the terminals which have performed this control.

Furthermore, when using information and an information processing function, it is also possible to employ the services of an information processing services provision vendor. For example, when a user wishes to employ the services of an information processing services provision vendor which provides a web based information processing function to client organizations, he must install platform software such as a web browser or the like upon his terminal in advance. When he accesses the computer which provides the service with this platform software upon his terminal, the software for operating upon his terminal is downloaded from the computer to the terminal, and information processing is then implemented by the software which has been downloaded and the computer cooperating together. With this type of web based system, information processing software need not be installed upon the terminal for each information processing function, so that it is possible to anticipate a reduction of the management cost for the terminals, since there is no necessity to manage the information processing software upon the terminals. Moreover it is possible to expect that it will become much harder for information to leak from the terminals, since the information is managed by the computer that provides the information processing service.

### [Patent Citation 1]

### Japanese Laid-Open Patent Publication 2005-216253

### [Patent Citation 2]

### Japanese Laid-Open Patent Publication 2005-235159

### DISCLOSURE OF INVENTION

### Technical Problem

Even if a centralized type information processing system or an information processing system which utilizes the services of an information processing services provision vendor is constructed, this does not completely eliminate the risk of information leakage from the terminal which the user is using. For example, information leakage may take place if a key logger which steals keyboard input information or some spyware which steals screen information gets into the terminal. Moreover, if a plurality of information processing services are used by the terminal, information leakage may take place, from one information processing service which is managing information, via the platform software on the terminal, to another information processing service. In order to prevent this type of information leakage from the terminal, it has been considered to introduce a quarantine system which checks the state of the terminal with regard to information leakage countermeasure.

A prior art type quarantine system has a function of controlling access to the network before connection to the network has started, however, can not check the state of the terminal after connection to an information processing server which provides an information processing service and before the utilization of the information processing service has started. Due to this, information leakage may take place if, after connection to the information processing server and right before information processing or utilization of the information processing service has started, a state is established in which some software or information processing service which has a problem is operating. Moreover since, during information processing or the utilization of an information processing service, it is not possible to impose any limitation upon the execution of other information processing or the utilization of another information processing service, accordingly, for example, it has been difficult to prevent the leakage of important data or information which has been temporarily stored in the terminal via that other information processing or that other information processing service.

The present invention has been conceived in consideration of the problem described above, and it takes it as its objective to provide an information processing limitation system, An information processing apparatus, and an information processing limitation program, which, during utilization of an information service, can prevent information leakage before it even happens.

### Technical Solution

In order to attain the above objects, the present invention proposes an information processing limitation system comprising: a server computer which provides an information processing service; and a computer which is coupled to the server computer, and which utilizes the information processing service; wherein the computer comprises a limitation part which, when the computer utilizes the information processing service, limits the utilization of the information processing service on the basis of a security state which is required for the utilization of the information processing service.

Furthermore, in order to attain the above objects, the present invention proposes An information processing apparatus which is coupled to a server computer which provides an information processing service, and which utilizes the information processing service, comprising a limitation part which, when the computer utilizes the information processing service, limits the utilization of the information processing service on the basis of a security state which is required for the utilization of the information processing service.

Yet further, in order to attain the above objects, the present invention proposes an information processing limitation program which is executed by a computer which is coupled to a server computer which provides an information processing service, and which utilizes the information processing service, comprising a limitation step of, when the computer utilizes the information processing service, limiting the utilization of the information processing service on the basis of a security state which is required for the utilization of the information processing service.

According to the present invention, since, during utilization of this information processing service, the utilization of that information processing service is limited on the basis of a security state which is required for the utilization of that information processing service, accordingly it is possible to limit the utilization of that information processing service after having coupled to a server computer which provides that information processing service, and directly before utilizing that information processing service.

### ADVANTAGEOUS EFFECTS

According to the present invention it is possible, after having coupled to a server computer which provides an information processing service, and right before utilizing that information processing service, to limit the utilization of that information processing service. Due to this, if the security state which is required when utilizing that information processing service is not satisfied, it is possible to limit the utilization of that information processing service, and thus it is possible to prevent the leakage of information due to the utilization of that information processing service, before it even happens.

### BRIEF DESCRIPTION OF DRAWINGS

FIG. 1 is a general structural diagram for explanation of the overall structure of an information processing limitation system according to the present invention.

FIG. 2 is a structural diagram for explanation of the structure of a terminal shown in FIG. 1.

FIG. 3 is a structural diagram for explanation of the structure of a management computer shown in FIG. 1.

FIG. 4 is a structural diagram for explanation of the modular structure of a terminal function limitation program shown in FIG. 2 and of a function limitation management program shown in FIG. 3.

FIG. 5 is a figure for explanation of the structure of a checking data list shown in FIGS. 2 and 3.

FIG. 6 is a figure for explanation of the structure of a function limitation data list shown in FIGS. 2 and 3.

FIG. 7 is a figure for explanation of the structure of a simultaneous function usage limitation data list shown in FIGS. 2 and 3.

FIG. 8 is a figure for explanation of the structure of a monitor subject function data list shown in FIG. 2.

FIG. 9 is a flow chart for explanation of the terminal function limitation program shown in FIG. 2.

FIG. 10 is a structural diagram for explanation of the structure of a terminal according to a second embodiment of the present invention.

FIG. 11 is a structural diagram for explanation of the structure of a management computer according to this second embodiment of the present invention.

FIG. 12 is a structural diagram for explanation of the modular structure of a terminal function limitation program shown in FIG. 10 and of a function limitation management program shown in FIG. 11.

FIG. 13 is a figure for explanation of the structure of a user data list shown in FIG. 11.

FIG. 14 is a figure for explanation of the structure of an information processing service log-in user data list shown in FIG. 11.

FIG. 15 is a timing chart for explanation of operation related to the start of utilization of an information processing service, in this second embodiment of the present invention.

FIG. 16 is a timing chart for explanation of operation related to reconnection to an information processing service, in this second embodiment of the present invention.

FIG. 17 is a timing chart for explanation of operation related to changing of the password for access to an information processing service, in this second embodiment of the present invention.

FIG. 18 is a structural diagram for explanation of the structure of a terminal in a third embodiment of the present invention.

FIG. 19 is a structural diagram for explanation of the structure of a management computer in a third embodiment of the present invention.

FIG. 20 is a figure for explanation of the structure of a protection subject service data list shown in FIG. 18.

FIG. 21 is a figure for explanation of the structure of a function limitation data list shown in FIG. 18.

FIG. 22 is a timing chart for explanation of operation related to utilization of an information processing service, in this third embodiment of the present invention.

FIG. 23 is a timing chart for explanation of operation related to creation of the above protection subject service data list, in this third embodiment of the present invention.

### EXPLANATION OF THE REFERENCE SYMBOLS

100 . . . information processing limitation system

### BEST MODE FOR CARRYING OUT THE INVENTION

In the following, various embodiments of the present invention will be explained with reference to the drawings.

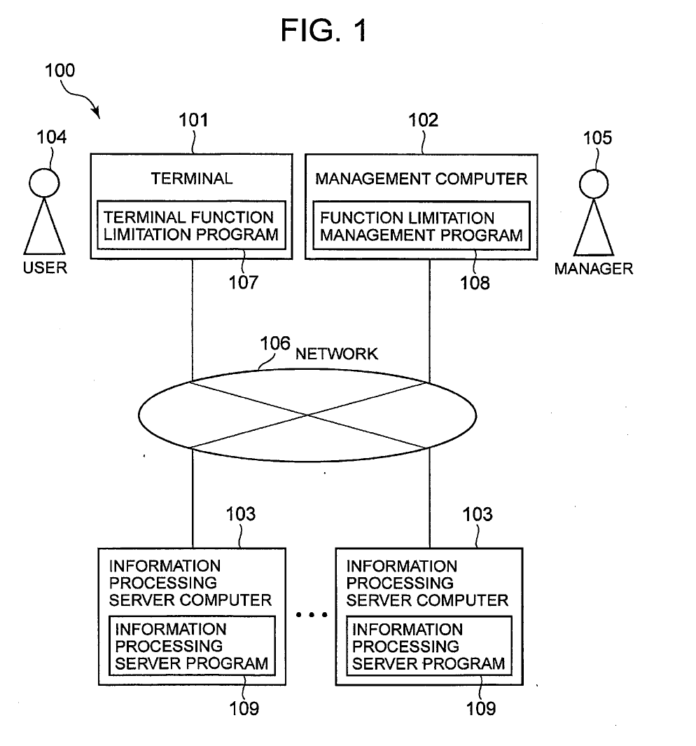

In the following, a first embodiment of the present invention will be explained using FIGS. 1 through 9. This first embodiment of the present invention is a method which focuses upon a program which performs function limitation within the terminal computer for, when a terminal computer is executing an information processing function (including information processing within the terminal computer by software or the like or utilization of a centralized type information processing system or information processing service), implementing a method of checking the state of the terminal computer before starting the execution of the information processing or starting the utilization of the information processing service, and limiting other simultaneous execution of information processing, or other simultaneous usage of some other information processing service, during the execution of that information processing or during the utilization of that information processing service.

First, the structure of an information processing limitation system according to a first embodiment of the present invention will be explained using FIGS. 1 through 3. FIG. 1 is a general structural diagram for explanation of the overall structure of this information processing limitation system according to the present invention.

The information processing limitation system 100 comprises a terminal computer (hereinafter termed the “terminal” 101, a function limitation management computer (hereinafter termed the “management computer”) 102, and a plurality of information processing servers 103.

The terminal 101 is a computer which is operated by a human user 104. This terminal 101 is connected to the information processing server computers 103 via a network 106, and utilizes information processing services provided by these information processing server computers 103. Moreover, the terminal 101 is endowed with an information processing function of being able to perform a plurality of information processing tasks simultaneously, and this information processing function is also executed when using information processing services. It should be understood that, generally, “information processing” is what is executed when utilizing an information processing service, but, in the present invention, “information processing” and “information processing along with utilizing an information processing service” are distinguished; it will be supposed that execution of “information processing along with utilizing an information processing service” is not included in the execution of information processing, but is included in the utilization of an information processing service.

Information processing server programs 109 run on the information processing server computers 103, which are computers which provide information processing services to terminals such as the terminal 101 which access them.

A function limitation management program 108 runs on the management computer 102, which is a computer which manages the details of function limitation implemented upon the terminal 101, as will be described hereinafter. A human function limitation manager (hereinafter termed a “manager”) 105 is able to alter the details of function limitation, using a function limitation management program 108. Moreover, the function limitation management program 108 transmits the details of function limitation to the terminal 101 via the network 106. And a function limitation program 107 upon the terminal 107 implements function limitation according to the details of function limitation which it has received.

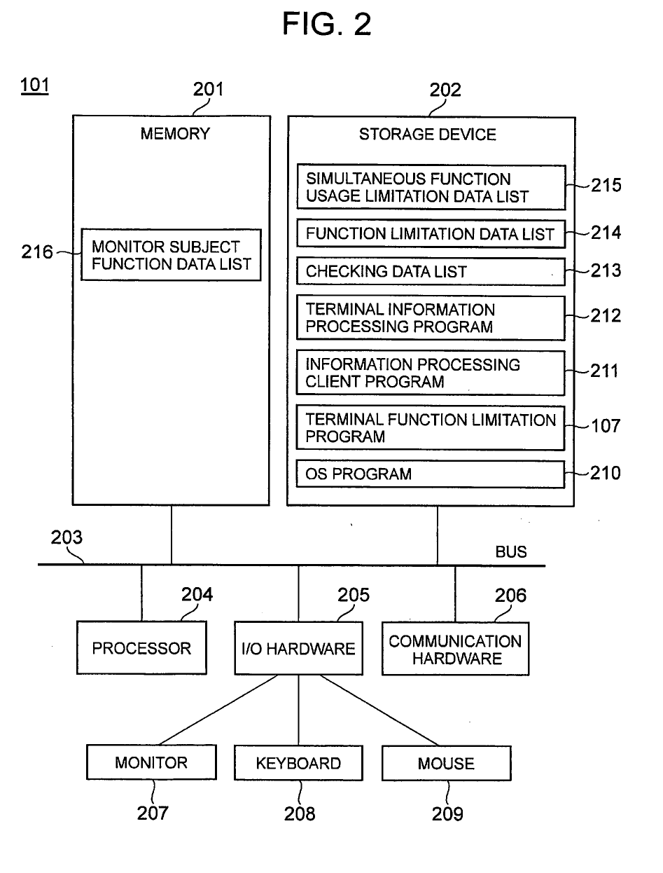

FIG. 2 is a structural diagram for explanation of the structure of the terminal 101 shown in FIG. 1. The terminal 101 comprises a memory 201, a storage device 202, a bus 203, a processor 204, I/O hardware 205, communication hardware 206, a monitor 207, a keyboard 208, and a mouse 209.

The processor 204 is a device which performs processing of programs. The storage device 202 is a device which stores programs and data, and is a hard disk or a non-volatile memory or the like. The memory 201 is a storage device for performing storage of programs which are being executed and storage of temporary data. The I/O hardware 205 is equipment for controlling output to the monitor 207 and input from the keyboard 208 and the mouse 209. And the communication hardware 206 is equipment for controlling network circuits to other computers.

Programs and data of various types are stored in the storage device 202 for implementing the function limitation method of this embodiment. An OS (Operating System) program 210, a terminal function limitation program 107, a terminal information processing program 212, and an information processing client program 211 are included in these programs which are stored. And a checking data list 213, a function limitation data list 214, and a simultaneous function usage limitation data list 215 are included in this data which is stored. The checking data list 213 is data which maintains a list of items to be checked, in order to check the state of the terminal 101. The function limitation data list 214 is data which maintains a list of functions for which limitation of usage by the terminal is to be performed. And the simultaneous function usage limitation data list 215 is data which maintains a list of functions for which limitation of simultaneous usage by the terminal is to be performed.

The OS program 210 upon the storage device 202 is loaded into the memory 201 and executed. This OS program 210 performs control of the I/O hardware 204, control of the communication hardware 206, loading of data from the storage device 202 into the memory 201, and so on. Moreover, this OS program 210 loads the terminal function limitation program 107, the terminal information processing program 212, and the information processing client program 211 from the storage device 202 into the memory 201, and executes them. This terminal function limitation program 107 which is executed from the OS program 210 performs function limitation for the terminal 101. At this time, a monitor subject function data list 216 is created in the memory 201 and utilized. This monitor subject function data list 216 is data which maintains a list of functions for which function limitation is being implemented, and is also used when canceling function limitation, and when canceling simultaneous usage limitation. The terminal information processing program 212 is a program which is processed by an information processing function, when information processing is to be executed. And the information processing client program 211 is a program which is processed by the information processing function, when an information processing service is to be utilized.

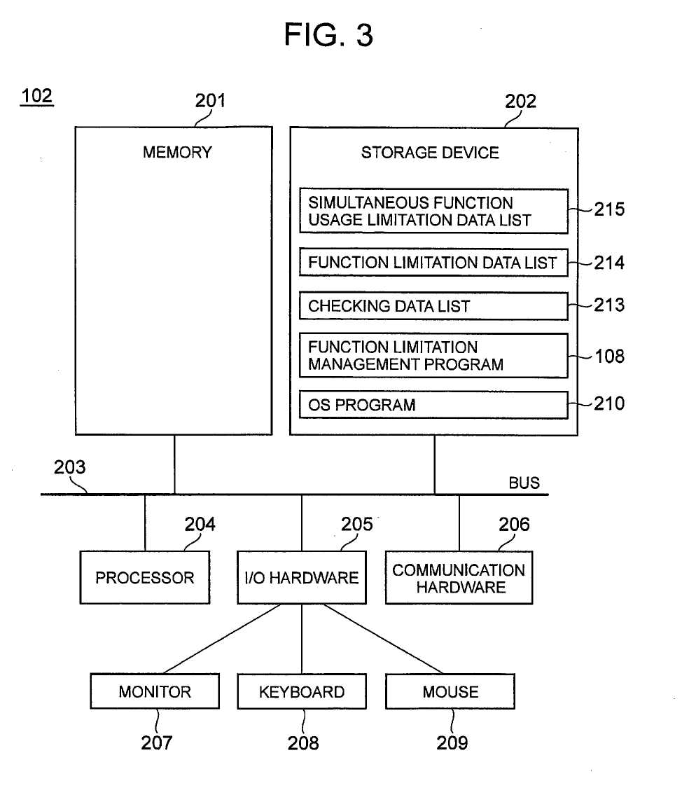

FIG. 3 is a structural diagram for explanation of the structure of the management computer 102 shown in FIG. 1. Programs and data of various types for implementing the function limitation method according to this embodiment are stored in a storage device 202 of this management computer 102. An OS (Operating System) program 210 and a function limitation management program 108 are included in these programs which are stored. And the checking data list 213, the function limitation data list 214, and the simultaneous function usage limitation data list 215 are included in the data structures which are stored. Each of these data structures is managed by the management computer 102, and is transferred to the terminal 101 upon a request from the terminal 101.

The OS program 210 upon the storage device 202 is loaded into the memory 201 and executed. This OS program 210 performs control of the I/O hardware 204, control of the communication hardware 206, loading of data from the storage device 202 into the memory 201, and so on. Moreover, this OS program 210 loads the function limitation management program 108 from the storage device 202 into the memory 201, and executes it. This terminal function limitation program 108 which is executed from the OS program 210 performs management of the checking data list 213, the function limitation data list 214, and the simultaneous function usage limitation data list 215. Moreover, it provides an interface to the manager 105 for changing these data items 213 through 215.

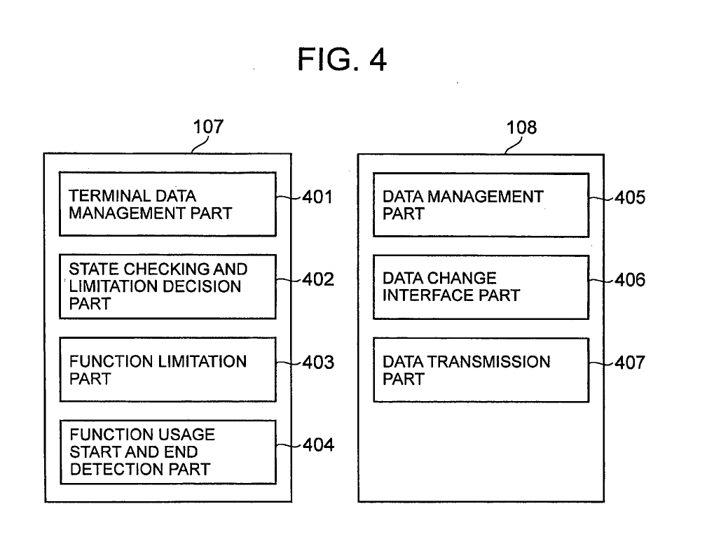

Next, the modular structure of the terminal function limitation program 107 and the function limitation management program 108 according to the first embodiment of the present invention will be explained with reference to FIG. 4.

FIG. 4 is a structural diagram for explanation of the part structure of the terminal function limitation program 107 shown in FIG. 2 and of the function limitation management program 108 shown in FIG. 3. As shown in FIG. 4, the terminal function limitation program 107 includes a terminal data management part 401, a state checking and limitation decision part 402, a function limitation part 403, and a function specification start and end detection part 404.

The terminal data management part 401 is a part which gets the newest checking data list 213, function limitation data list 214, and simultaneous function usage limitation data list 215 from the management computer 102, and performs processing to update the various data structures upon the terminal 101. The state checking and limitation decision part 402 is a part which checks the state of the terminal 101 according to the details of the checking data list 213 and the function limitation data list 214, determines the security level of the terminal 101, and makes decisions as to whether or not to perform function limitation. The function limitation part 403 is a part which performs limitation, and cancellation of limitation, of execution of the information processing functions of the terminal 101 (i.e. of the processing by the terminal information processing program 212 and of the processing by the information processing client program 211), and of operation by the user 104. And the function usage start and end detection part 404 is a part which performs processing for detection of starting and ending of execution of the information processing function of the terminal 101 and of utilization by the user.

As shown in FIG. 4, the function limitation management program 108 consists of a data management part 405, a data change interface part 406, and a data transmission part 407. The data management part 405 is a part which performs processing to manage the checking data list 213, the function limitation data list 214, and the simultaneous function usage limitation data list 215 of the management computer 102. The data change interface part 406 provides an interface to the manager 105 for changing various data items. And the data transmission part 407 is a part which performs processing to transmit various data items to the terminal 101, according to requests from the terminal 101.

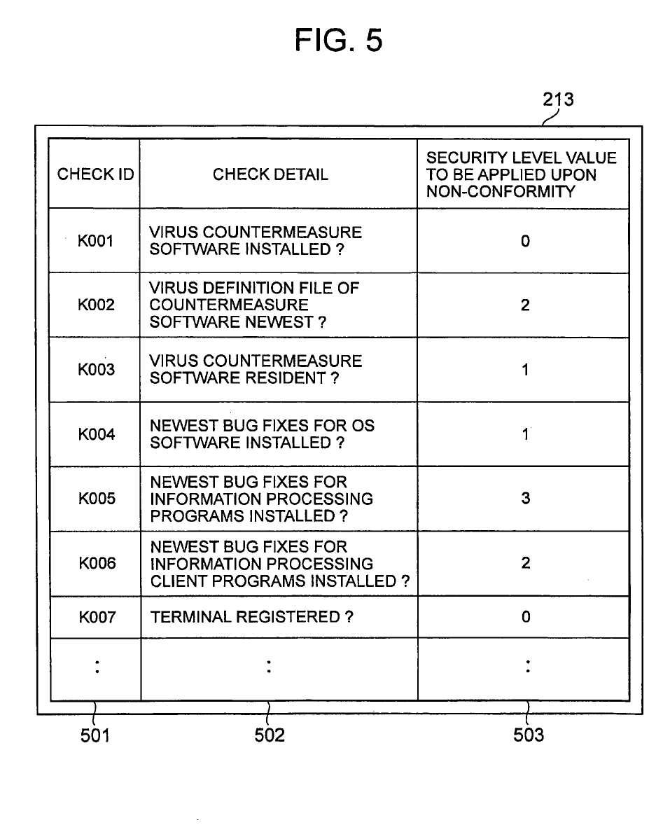

Next, the data structures in this information processing limitation system according to the first embodiment of the present invention will be explained with reference to FIGS. 5 through 8.

FIG. 5 is a figure for explanation of the structure of the checking data list 213 shown in FIGS. 2 and 3. As shown in FIG. 5, the checking data list 213 has some fields which are a check ID 501, a check detail 502, and a 503 for the value of the security level to be applied upon non-conformity. The check ID 501 is a field in which is held an identifier for an item which is to be checked in relation to the state of the terminal 101, this identifier being unique within the information processing limitation system 100. The check detail 502 is a field in which is held the details of this check to be performed upon the state of the terminal 101 corresponding to the check ID 501. And the security level to be applied upon non-conformity 503 is a field in which is held a security level to be applied, when it has been decided that the result of checking the state of the terminal 101 is that it does not conform to the check. The manager 105 configures the value in this security level value to be applied upon non-conformity 503 in accordance with organizational objectives.

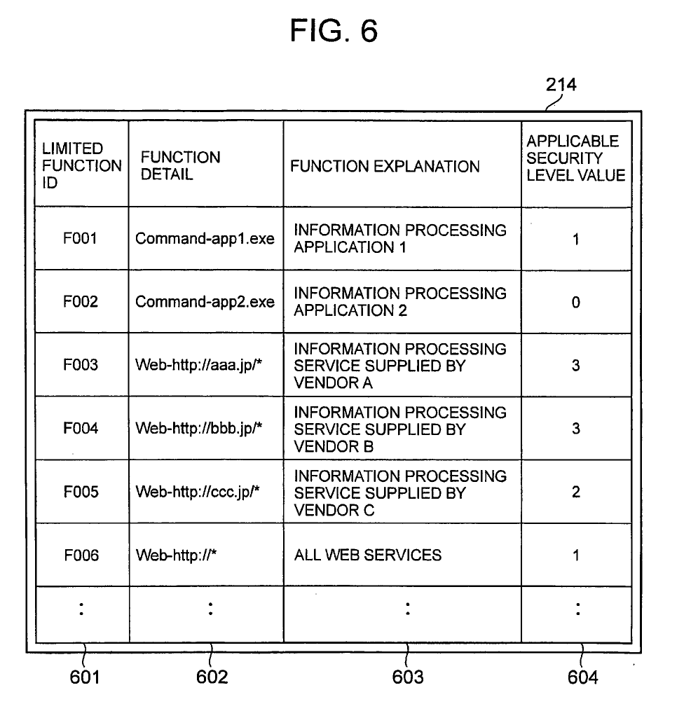

FIG. 6 is a figure for explanation of the structure of the function limitation data list 214 shown in FIGS. 2 and 3. As shown in FIG. 6, the function limitation data list 214 has some fields which are a limited function ID 601, a function detail 602, a function explanation 603, and an applicable security level value 604. The limited function ID 601 is a field in which is held an identifier for a function which is to be an object of limitation, this identifier being unique within the information processing limitation system 100. The function detail 602 is a field in which is held the details of the function corresponding to the limited function ID 601, i.e. an identifier of some information processing application which is executed by the terminal information processing program 212, or an identifier of an information processing service which is accessed by the information processing client program 211. The function explanation 603 is a field in which is held explanatory text for the function which corresponds to the limited function ID 601. And the applicable security level value 604 is a field in which is held a security level for the terminal 101 which can be applied without applying any utilization limitation to the function which corresponds to the limited function ID 601. The manager 105 configures the values in this function limitation data list 214 in accordance with organizational objectives.

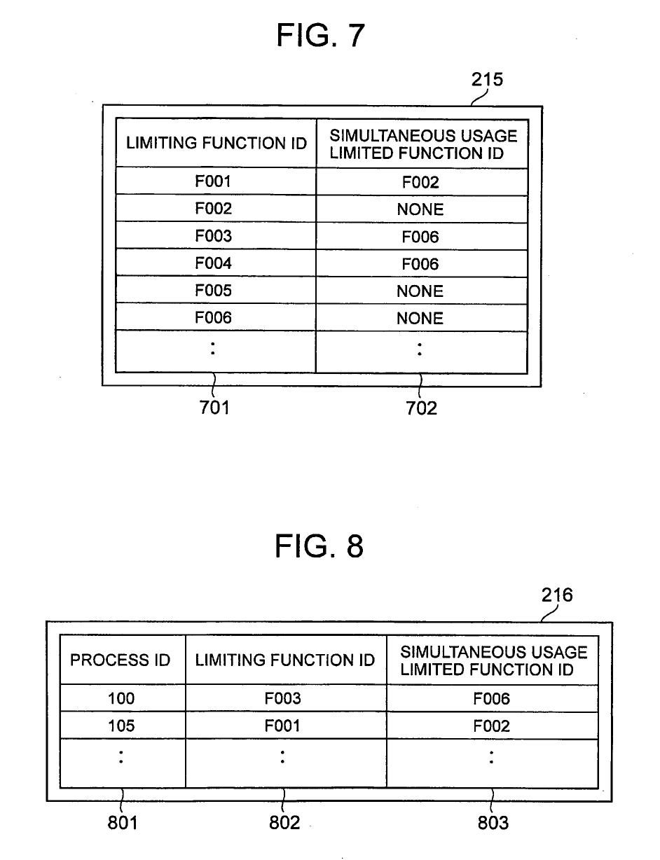

FIG. 7 is a figure for explanation of the structure of the simultaneous function usage limitation data list 215 shown in FIGS. 2 and 3. As shown in FIG. 7, the simultaneous function usage limitation data list 215 has some fields which are a limiting function ID 701 and a simultaneous usage limited function ID 702. The limiting function ID 701 is a field in which is held an identifier for a function which is to be a subject that causes limitation. And the simultaneous limited function ID 702 is a field in which is held the function ID of the function which is to be limited, during execution or during application of the function which corresponds to the limiting function ID 701. For example, an item is shown which specifies that, during execution or during application of the function “F001” named in the limiting function ID 701, the function “F002” named by the value held in the limited function ID 702 is to be limited. The manager 105 configures the values in this simultaneous function usage limitation data list 215 in accordance with organizational objectives.

FIG. 8 is a figure for explanation of the structure of the monitor subject function data list 216 shown in FIGS. 2 and 3. As shown in FIG. 8, the monitor subject function data list 216 has some fields which are a process ID 801, a limiting function ID 802, and a simultaneous usage limited function ID 803. The process ID 801 is a field in which is held the identifier of a program which is running upon the terminal 101, and which is, for example, created by the OS program 210. The limiting function ID 802 is a field in which is held a limiting function ID of the function which is provided by the program named in the process ID 801. And the simultaneous usage limited function ID 803 is a field in which is held a limited function ID of a function which is to be the object of limitation, during the operation or the application of the function named in the limiting function ID 802. The information processing limitation program 107 adds to the monitor subject function data list 216 when function limitation is to be performed, and deletes from the monitor subject function data list 216 and cancels the limitation of the simultaneous usage limited function described in the simultaneous usage limited function ID 803, when function limitation is to be cancelled.

When the user 104 of this system is using the terminal 101 to execute an information processing function upon the information processing limitation system 100 having the structure described above, the execution of the information processing function is limited according to the state of the terminal 101. The terminal function limitation program 107 of the terminal 101 is started by the OS program 210 when the terminal 101 starts, is made to be resident in the memory during the starting of the terminal 101, and always runs during the operation of the terminal 101.

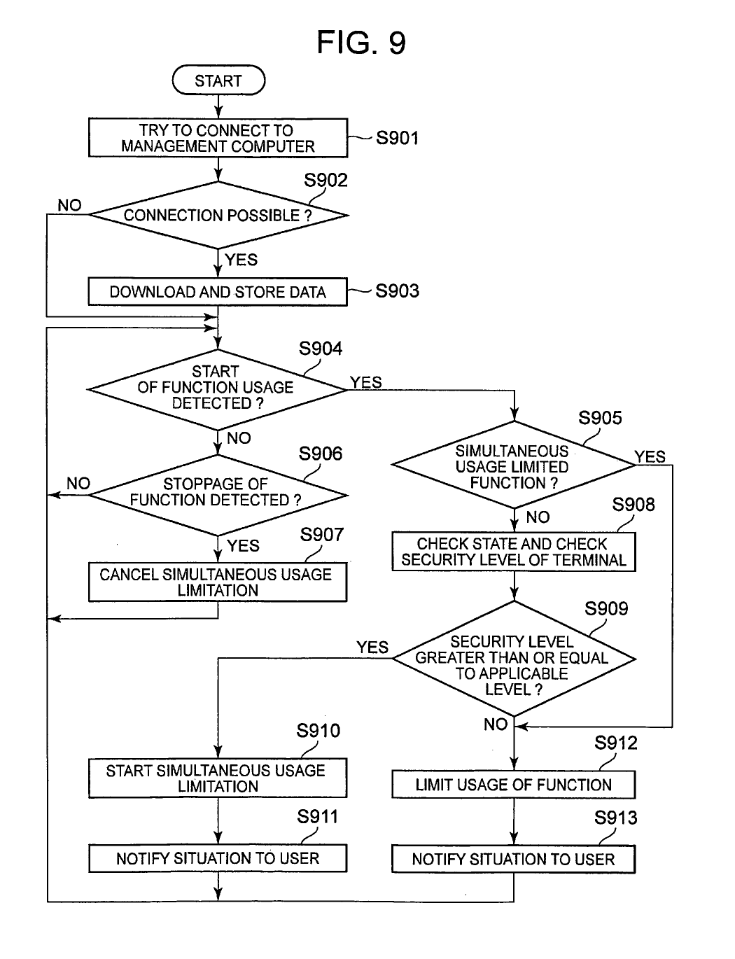

Next, the operation of this information processing limitation system according to the first embodiment of the present invention will be explained using FIG. 9.

FIG. 9 is a flow chart for explanation of the terminal function limitation program 107 shown in FIG. 2. First, this terminal function limitation program 107 tries to connect to the function limitation management computer 102 via the network (S901). Next, the terminal function limitation program 107 makes a decision as to whether or not it has been possible to connect to the management computer 102 (S902), and, if it thus been possible to connect, via the network 106, it obtains the checking data list 213, the function limitation data list 214, and the simultaneous function usage limitation data list 215 which are being managed by the management computer 102, and stores them in the storage device 202 of the terminal 101 (S903). But, if it has not been possible to connect to the management computer 102, the flow of control is transferred directly to S904.

Next, the terminal function limitation program 107 reads out the checking data list 213, the function limitation data list 214, and the simultaneous function usage limitation data list 215 from the storage device 202, and operates while using this data. First, a decision is made as to whether or not the start of execution or the start of application of a limited function which is mentioned in the function limitation list 214 has been detected (S904). Whether or not the start of execution or the start of application of a limited function has been detected may be performed, for example, by the terminal function limitation program 107 executing any of the followings (1) through (3):

(1) monitoring all of the network packets and making a decision, and, before the network packets are transmitted to the information processing server computer 103 via the network 106, making a decision as to whether or not there is any network packet containing a URL which is described in a function detail 602 of the function limitation data list 214;
(2) installing add-in software which acquires a connection command to a web browser, and making a decision as to whether or not a connection command which has been acquired by this add-in software requests, as its destination for connection, a URL which is described in the function limitation data list 214;
(3) cooperating with the OS program 210, receiving a system call command of the OS program 210 before the software starts, and making a decision as to whether or not some software described in the function limitation data list 214 is to be executed.

If the start of execution or the start of application of a limited function which is carried in the function limitation list 214 has been detected, the terminal function limitation program 107 makes a decision as to whether or not the limited function which has been detected is described in some simultaneous usage limited function ID 803 of the monitor subject function data list 216 (S905). And, if the limited function which has been detected is described in a simultaneous usage limited function ID 803 of the monitor subject function data list 216, the flow of control is transferred to S912 which will be described hereinafter.

But, if the limited function which has been detected is not described in any simultaneous usage limited function ID 803 of the monitor subject function data list 216, the terminal function limitation program 107 checks the state of the terminal 101 for each of the checked items which are described in the checking data list 213, and determines the security level of the terminal 101 from the results of this checking (S908). This security level is the smallest value among the security level values to be applied upon non-conformity fields 503 of all of those checked items for which the terminal 101 has confirmed that they do not conform to their checked item states. For example, if only the checked item whose check ID is K002 does not conform, the security level is 2; while, if it has been confirmed that only the checked items whose check IDs are K002 and K003 do not conform, the security level becomes 1. Moreover, if the terminal 101 has confirmed that the state of all of the checked items conforms, the security level becomes 9 (maximum).

Next, the terminal function limitation program 107 makes a decision as to whether or not the security level determined in the S908 is greater than or equal to the applicable security level value 604 which corresponds to the limited function ID 601 for which the start of execution or the start of utilization was detected in the S904 (S909), and, if the security level is greater than or equal to the applicable security level value 604, the terminal function limitation program 107 makes function execution and utilization possible without imposing any limitation. In other words, if the security level of the terminal 101 which was required at the start of execution or the start of application of the limited function described in the function limitation list 214 detected in the S904, and checked in the S908, satisfies the condition that it provides a security state greater than or equal to the applicable security level value 604, this function is not limited.

At this time, if some simultaneous usage limited function ID 702 is present in the simultaneous function usage limitation data list 215 which corresponds to this limiting function ID 701 which has been made applicable, in other words, if the simultaneous usage limited function ID 702 is not “none”, limitation of the execution or utilization of the function which corresponds to that simultaneous usage limited ID 702 is performed (S910). In this limitation of execution or application of the function, for a function which is being executed or applied, the process for executing or applying this function is stopped, or stoppage of the user interface for executing or applying this function is performed. Moreover, for a function which is not being executed or applied, its starting is suppressed by adding, to the monitor subject function data list 216, a process ID 801, a limiting function ID 802, and a simultaneous usage limited function ID 803 related to the limiting function for which the start of execution or the start of application were detected in the S904. Since, in this manner, when utilizing an information processing service or in the execution of some information processing, the utilization of the information processing service or the execution of the information processing is limited on the basis of the simultaneous function usage limitation data list 215, accordingly it is possible to limit simultaneous usage of some predetermined information processing service or of some predetermined information processing, and of the information processing service or of the information processing, directly before the information processing service or directly before executing the information processing would be utilized.

When this simultaneous usage limitation has been implemented, the terminal function limitation program displays this situation upon the monitor or the like, so that it is notified to the user 104 (S911).

If the result of the decision in the S909 is that the security level which has been determined in the S908 is smaller than the applicable security level value 604 corresponding to the limited function ID 601 for which the start of execution or the start of application was detected in the S904, the terminal function limitation program 10 performs limitation of the execution or application of the function (S912). In other words, if the security level of the terminal 101 which was determined in the S908, required for the start of execution or the start of utilization, detected in the S904, of the limited function described in the function limitation list 214, does not satisfy the condition of being a security state which is greater than or equal to the applicable security level value 604, then this function is limited. This limitation of the execution or utilization of the function is performed by stopping the start of usage of the previously described web browser or OS program or the like, or by stopping its user interface. Since, in this manner, when utilizing an information processing service, the utilization of that information processing service is limited on the basis of the security level of the terminal 101 determined in the S908 and the applicable security level value 604, accordingly it is possible, after having connected to the information processing service computer 103 which provides the information processing service, to limit the utilization of that information processing service directly before utilizing the information processing service. Moreover, when executing information processing, it is possible to limit the execution of that information processing directly before the information processing would be executed, since the limitation of that information processing is executed on the basis of the security level which is determined in the S908 and the applicable security level value 604.

When this function limitation has been implemented, this situation is displayed upon the monitor or the like, so that it is notified to the user 104 (S913).

If in the S905 the start of execution or the start of application of a function has not been detected, the terminal function limitation program 107 makes a decision as to whether or not the stoppage of execution or the stoppage of utilization of a limiting function which is carried in the monitor subject function data list 216 has been detected (S906). This detection as to whether or not the stoppage of execution or the stoppage of utilization of a limiting function has been detected may, for example, be decided upon according as to whether or not the various process ID fields 801 which are described in the monitor subject function data list 216 are present in a list of processes being executed, which the OS program 210 maintains.

If the stoppage of execution or the stoppage of utilization of some limiting function has been detected, the limitation of the function described in the simultaneous usage limited function ID 803 corresponding to the process ID field of the function which has been stopped is cancelled (S907). This cancellation of the limitation of the function is performed by deleting the corresponding process ID 801 from the monitor subject function data list 216, or by making it possible to utilize the user interface of the corresponding process ID 801.

Although in this embodiment it is arranged, in the S903, to get the checking data list 213, the function limitation data list 214, and the simultaneous function usage limitation data list 215 which are being managed by the management computer 102, and to store them in the storage device 202, this is not to be considered as being limitative; it would also be acceptable to arrange to store them in the storage device 202 of the terminal 101 in advance, or not to store them in the storage device 202, but rather to store them upon some media which can be accessed by the terminal 101, such as, for example, a USB type flash memory or a memory card or a CD-ROM or the like.

Since, in this manner, according to this embodiment, when utilizing an information processing service, the utilization of the information processing service is limited on the basis of the security level of the terminal 101 which is determined in the S908, and on the basis of the applicable security level value 604, accordingly it is possible to limit the utilization of the information processing service after having connected to the information processing server computer 103 which provides the information processing service, and directly before utilizing the information processing service. Due to this it is possible, when the security state which is required when utilizing the information processing service is not satisfied, to limit the utilization of that information processing service, and thus it is possible to prevent the leakage of information due to the utilization of that information processing service, before it even happens.

Furthermore since, when performing information processing, the execution of this information processing is limited on the basis of the security level of the terminal 101 which is determined in the S908, and on the basis of the applicable security level value 604, accordingly it is possible to limit the execution of the information processing directly before executing the information processing. Due to this it is possible, when the security state which is required when executing the information processing is not satisfied, to limit the execution of that information processing, and thus it is possible to prevent the leakage of information due to the execution of that information processing, before it even happens.

Moreover since, when utilizing an information processing service or when executing information processing, utilization of that information processing service or execution of that information processing is limited on the basis of the simultaneous function usage limitation data list 215, accordingly, directly before utilizing the information processing service or directly before executing the information processing, it is possible to limit the simultaneous usage of some predetermined information processing service or some predetermined information processing, and the information processing service or the information processing. Due to this it is possible, when utilizing that information processing or when executing that information processing, to prevent the leakage of information via the utilization of that predetermined information processing service or via the execution of that predetermined processing, before it even happens.

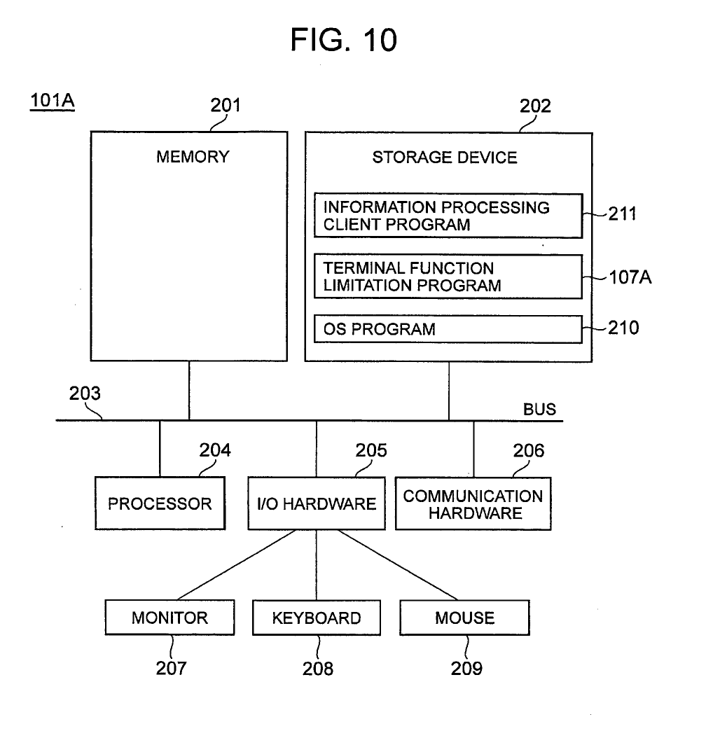

Next, a second embodiment of the present invention will be explained using FIGS. 10 through 15. This second embodiment of the present invention is a way in which, when an information processing service is being utilized by one or more terminals, in a method of checking the state of a terminal before its usage starts and of limiting simultaneous usage of the information processing services during use, this limitation is implemented by putting to practical use user authentication to the information processing service. Although user authentication is used in this embodiment, some other method such as, for example, terminal authentication or the like would also be acceptable, provided that there is some way of using a control function for access to the information processing service. It should be understood that to elements which are the same as ones of the first embodiment described above, the same reference symbols are affixed, and detailed explanation thereof is omitted.

Since the overall structure of this information processing limitation system 100A according to the second embodiment of the present invention is the same as the overall structure of the information processing limitation system 100 according to the first embodiment of the present invention as shown in FIG. 1, it is not shown in the figures, and explanation thereof will be omitted. An outstanding point of difference between this second embodiment and the first embodiment is that it is arranged to use a terminal 101A instead of the terminal 101, and a management computer 102A instead of the management computer 102.

FIG. 10 is a structural diagram for explanation of the structure of a terminal 101A in this second embodiment of the present invention. The difference from the terminal 101 in the first embodiment shown in FIG. 2, is that an OS program 210, a terminal function limitation program 107A, and an information processing client program 211 are stored as programs in the storage device 202 of this terminal 101A.

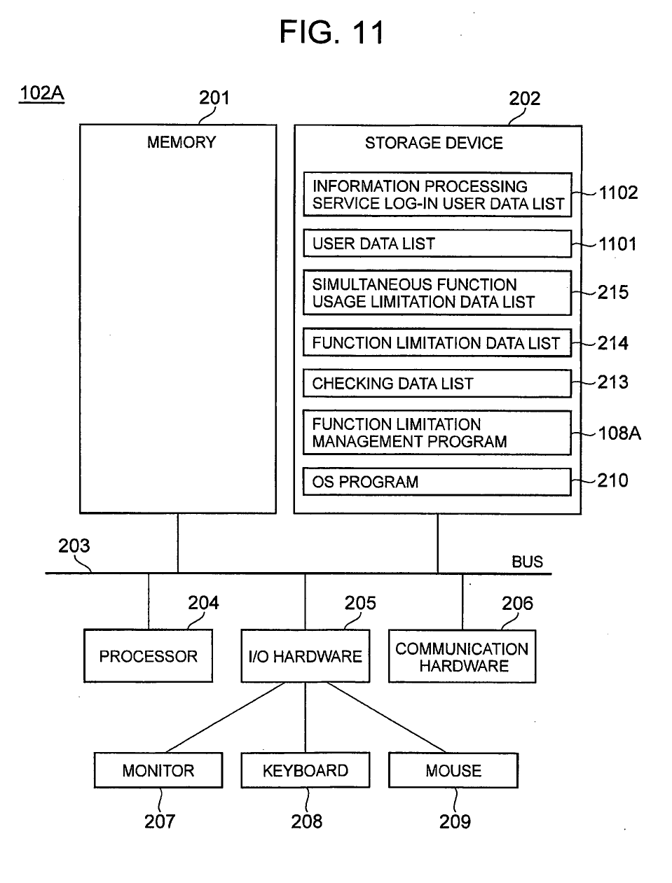

And FIG. 11 is a structural diagram for explanation of the structure of a management computer 102A in this second embodiment of the present invention. The difference from the management computer 102 in the first embodiment shown in FIG. 3, is that, in addition to the previously described OS program 210, checking data list 213, function limitation data list 214, and simultaneous function usage limitation data list 215, a function limitation management program 108A is also stored as a program in the storage device 202 of this management computer 102A; and a user data list 1101 and an information processing service log-in user data list 1102 are also stored as data therein.

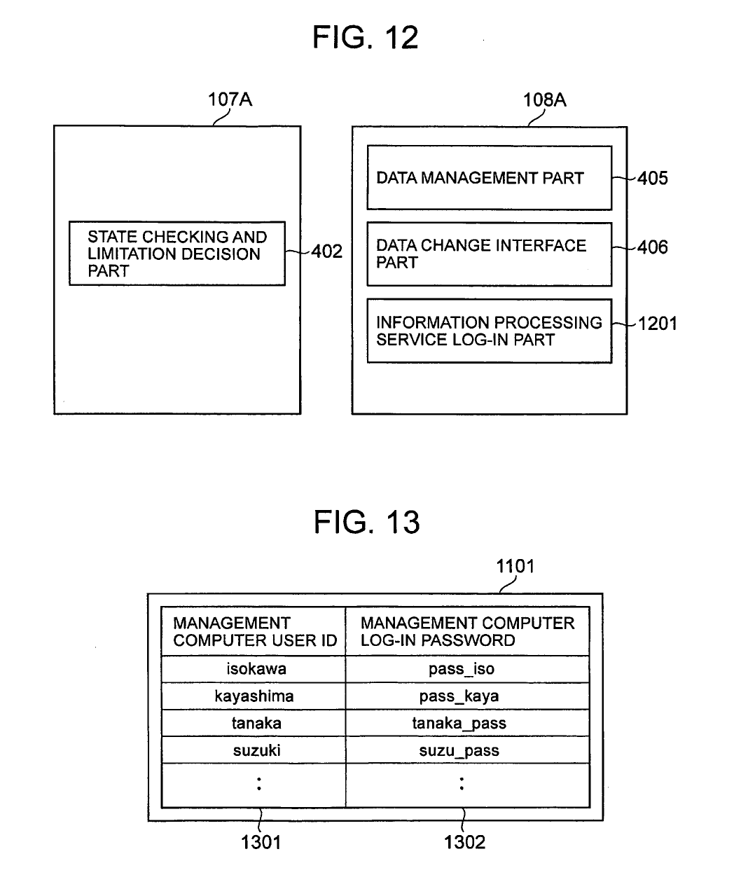

Next, the modular structure of the terminal function limitation program 107A and the function limitation management program 108A according to this second embodiment of the present invention will be explained with reference to FIG. 12.

FIG. 12 is a structural diagram for explanation of the modular structure of the terminal function limitation program 107A shown in FIG. 10 and of the function limitation management program 108A shown in FIG. 11. The terminal function limitation program 107A comprises a state checking and limitation decision part 402. This state checking and limitation decision part 402 is a part which checks the state of the terminal 101A according to the details of the checking data list 213 which is sent from the management computer 102A, and determines the security level of the terminal 101A.

The function limitation management program 108A comprises a data management part 405, a data change interface part 406, and an information processing service log-in part 1201. The data management part 405 is a part which performs processing to manage the checking data list 213 and the function limitation data list 214 of the management computer 102A, and the simultaneous function usage limitation data list 215, the user data list 1101, and the information processing service log-in user data list 1102. The data change interface part 406 provides an interface to the manager 105 for changing various data items. And the information processing service log-in part 1201 is a part which provides an interface to the user 104 for changing the information processing service log-in user data list 1102 via the terminal 101A.

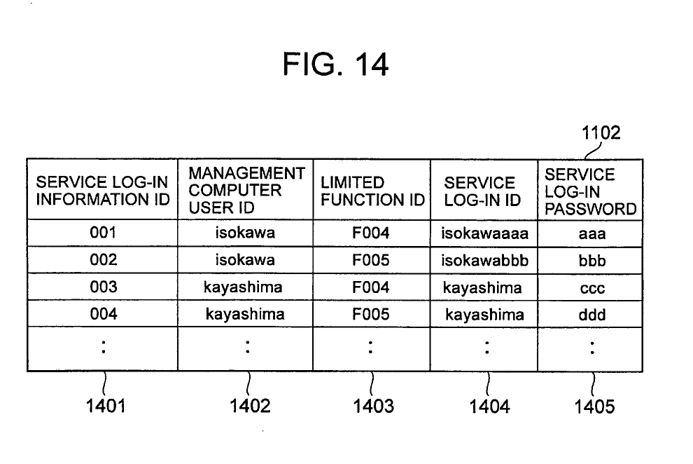

Next, the data structures of this information processing limitation system according to the second embodiment of the present invention will be explained using FIGS. 13 and 14.

FIG. 13 is a figure for explanation of the structure of the user data list 1101 shown in FIG. 11. As shown in FIG. 13, the user data list 1101 has some fields which are a management computer user ID 1301 and a management computer log-in password 1302. The user ID 1301 is a field in which is held the identifier of the user 104 when he logs in from the terminal 101A to the management computer 102A in order to take advantage of an information processing service. And the management computer log-in password 1302 is a field in which is held the password of the user 104 when he logs in to the management computer 102A at that time. If the pair consisting of the user ID and the password which have been inputted by the user 104 is present in the user data list 1101, the function limitation management program 108A of the management computer 102A is able to enable the user 104 to utilize the information processing service. The manager 105 configures the details of the user data list 1101 in advance, to match the user list of the organization.

FIG. 14 is a figure for explanation of the structure of the information processing service log-in user data list shown in FIG. 11. As shown in FIG. 14, the information processing service log-in user data list 1102 has some fields which are a service log-in information ID 1401, a management computer user ID 1402, a limited function ID 1403, a service log-in ID 1404, and a service log-in password 1405. The service log-in information ID 1401 is a field in which is held an identifier for managing a group consisting of a log-in ID and a log-in password to the information processing service which corresponds to this management computer ID. The management computer user ID 1402 is a field in which is held the log-in ID to the management computer 102A. The limited function ID 1403 is a field in which is held an identifier of an information processing service which is described in the function limitation data list 214. The service log-in ID 1404 is a field in which is held a log-in ID which is used when logging in to the information processing service which corresponds to the information processing service specified by the service log-in information ID 1401 and the limited function ID 1403. And the service log-in password 1405 is a field in which is held the password which is used when logging in to that information processing service. The user 104 registers his log-in ID and password to the information processing service in advance in this information processing service log-in user data list 1102.

With the information processing limitation system 100A having the structure described above, when a user 104 in the organization is employing the terminal 101A to utilize a information processing service, the utilization of the information processing service is limited according to the state of the terminal 101A.

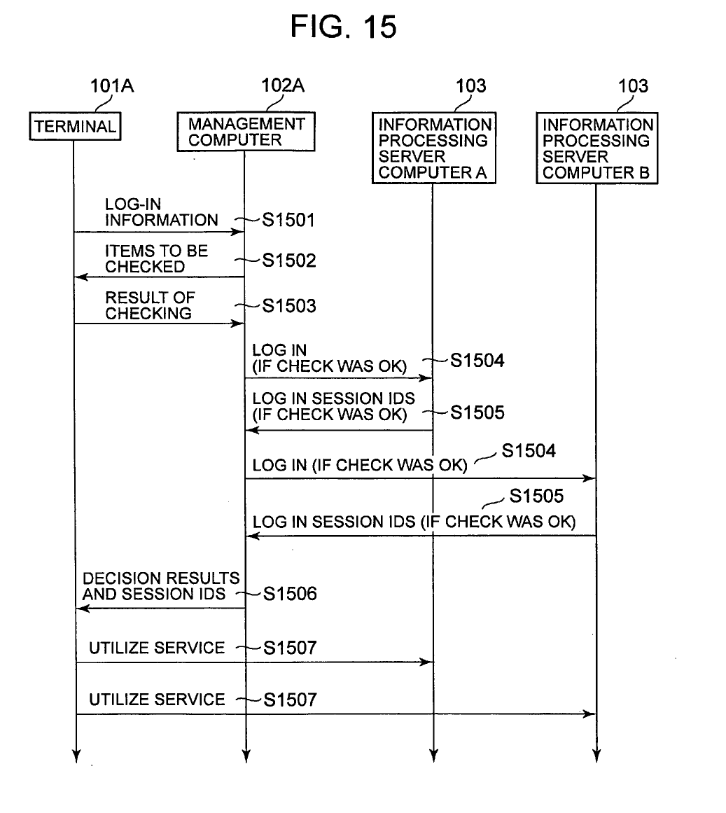

Next, the operation of this information processing limitation system according to the second embodiment of the present invention will be explained using FIGS. 15 through 17.

FIG. 15 is a timing chart for explanation of operation related to the start of utilization of an information processing service, in this second embodiment of the present invention.

First, the terminal 101A invites the user 104 to input a log-in ID and a log-in password to the management computer 102A, and then transmits the log-in ID and a log-in password which the user 104 has inputted in response, to the management computer 102A (S1501). The management computer 102A makes a decision, according to the user data list 1101, as to whether or not the log-in ID and the log-in password which have been transmitted are correct, and, if they are correct, returns the checking data list 213 to the terminal 101A (S1502). The terminal 101A checks the state of the terminal 101A according to the checking data list 213 and performs determination of the security level of the terminal 101A, and transmits the security level which has been confirmed back to the management computer 102A (S1503). And the management computer 102A performs logging in to each of the information processing server computers 103 which provides an information processing service for which the security level of the terminal 101A which has been transmitted is equal to or greater than its applicable security level value 604 in the function limitation data list 214 (S1504). In these log-ins to the information processing server computers 103, the service log-in ID fields 1404 and the service log-in password fields 1405 held in the information processing service log-in user data list 1102 are used. Moreover, for any information processing server computer 103 which provides an information processing service for which the security level of the terminal 101A which has been transmitted is smaller than the applicable security level value 604 in the function limitation data list 214, log-in is not performed, but rather function limitation is performed. When at least one log-in to each information processing server computer 103 which provides information processing services succeeds, then each information processing server computer 103 return log-in session ID, which constitute a temporary access key, to the management computer 102A (S1505).

If each log-in to each information processing server computer 103 which provide information processing service has succeeded, the management computer 102A returns the result of decision upon function limitation and the log-in session IDs to the terminal 101A (S1506). However, this reply does not include a log-in session ID where simultaneous usage has been limited by the simultaneous function usage limitation data list 215. Moreover, if log in to one of the information processing server computers 103 which provides an information processing service has failed, or if, due to function limitation, log-in has not been performed to one of the information processing server computers 103 which provides an information processing service, only the result of decision regarding function limitation is returned to the terminal 101A.

And the terminal 101A connects to each of the information processing server computers 103 which provides an information processing service using the log-in session ID which has been transmitted from the management computer 102A (S1507), and then the user 104 becomes able to utilize the information processing services which are provided by these information processing server computers 103 to which connection has been established. Since, in this manner, when utilizing the information processing services, this utilization of the information processing services is limited on the basis of the log-in results to the information processing server computers 103 which provide the information processing services as described in the function limitation data list 214, accordingly it is possible to determine, all at once, whether or not to limit the utilization of the entire plurality of information processing services.

It should be understood that, in this embodiment, the management computer 102A implements the log-ins to the information processing services, but this should not be considered as being limitative of the present invention; it would also be acceptable to arrange, in the case of there being no function limitation, for the management computer 102A to transmit the log-in ID and the password to an information processing service to the terminal 101A, and to log in to the information processing service from the terminal 101A. Furthermore although the management computer 102A performs the log-ins to those information processing services for which the security level of the terminal 101A which has been transmitted is the same or higher than the applicable security level value 604 of the function limitation data list 214, this should not be considered as being limitative either; it would also be acceptable to arrange for it to perform the log-ins while excluding those information processing services for which simultaneous usage is limited by the simultaneous function usage limitation data list 215.

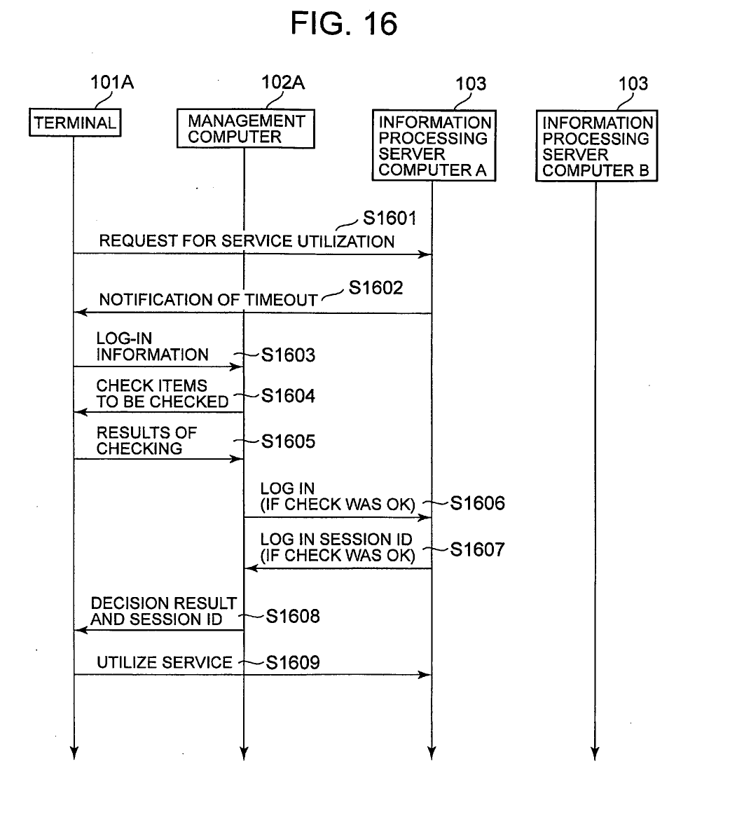

FIG. 16 is a timing chart for explanation of operation related to reconnection to an information processing service, in this second embodiment of the present invention.

If, while the user 104 is utilizing an information processing service, this information processing service has timed out, when a utilization request is transmitted to the information processing service (S1601), the information processing server computer 103 returns a timeout notification to the terminal 101A (S1602).

The terminal function limitation program 107A then invites the user 104 to input the log-in ID and the log-in password to the management computer 102A again, and then the log-in ID and the log-in password which the user 104 has inputted and information about the information processing service which has timed out are transmitted to the management computer 102A (S1603).

The management computer 102A makes a decision as to whether or not the log-in ID and the log-in password which have been transmitted are correct according to the user data list 1101, and, if they are correct, returns the checking data list 213 to the terminal 101A (S1604). Checking of the state of the terminal 101A according to the checking data list 213 and checking of the security level of the terminal 101A are performed by the terminal 101A, and then the security level which has been determined is transmitted to the management computer 102A (S1605).

If the information processing service which timed out is one of limited function as described in the function limitation data list 214, the management computer 102A makes a decision as to whether or not the security level of the terminal 101A which has been transmitted is greater than or equal to the applicable security level value 604 of the function limitation data list 214, and, if the security level of the terminal 101A is greater than or equal to the applicable security level value 604 of the function limitation data list 214, the computer 102A logs in to the information processing server computer 103 which provides the information processing service that time out (S1606). Furthermore, if the information processing service which timed out is not one of limited function as described in the function limitation data list 214, the management computer 102A logs in to the information processing server computer 103 which provides the information processing service and which has timed out, just as it is without further ado. If the log-in to the information processing server computer 103 has succeeded, the information processing server computer 103 returns a log-in session ID to the management computer 102A (S1607).

The management computer 102A returns the decision result for function limitation and the log-in session ID to the terminal 101A (S1608), and the terminal 101A then uses this log-in session ID which has been transmitted from the management computer 102A to connect to the information processing service again (S1609). Due to this, it is possible for the user 104 to resume utilization of the information processing service by using this session ID which has been obtained from the management computer 102A.

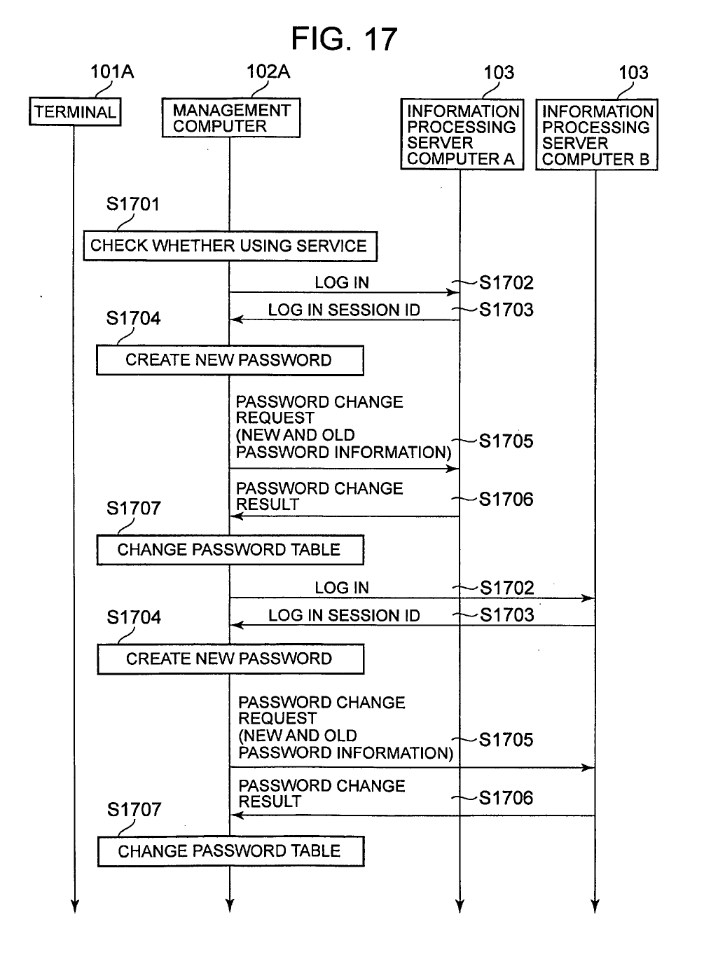

FIG. 17 is a timing chart for explanation of operation related to changing of a password, in this second embodiment of the present invention.

The terminal function limitation program 107A performs the following processing at a cycle whose period is determined in advance. Initially, the terminal function limitation program 107A makes a decision as to whether the user 104 is not utilizing some information processing service (S1701). This decision as to whether the user 104 is not utilizing the information processing service may be performed, for example, by deciding that the user 104 is not using the information processing service when he is not logged in to the management computer 102A for longer than some specified time interval, or by deciding that the user 104 is not using the information processing service in some time slot which is fixed such as late at night or the like.

If the user 104 is not utilizing some information processing service, the password change processing shown in the steps S1702 through S1706 for the corresponding information processing service is performed. First, the management computer 102A logs in to the information processing server computer 103 which provides the information processing service (S1702), and receives a log-in session ID (S1703). If it has been possible to log in and receive an log-in session ID, the management computer 102A creates a new password (S1704), and transmits a password change request to the information processing server computer 103 (S1705). At this time, the new password which has been created, and the current password according to a request from the information processing server computer 103, are both transferred to the information processing server computer 103. And the management computer 102A receives the result of password change from the information processing server computer 103 (S1706), and, if the password has been correctly changed, changes the contents of the service log-in password 1405 (S1707). Due to this, the user 104 does not himself need to change his password periodically.

Since in this manner, according to this embodiment, during the utilization of information processing services, the utilization of each information processing service is limited on the basis of the result of logging in to each information processing server computer 103 which provides one of the information processing services described in the function limitation data list, accordingly it is possible to perform limitation and non-limitation of usage of a plurality of information processing services, all together at once. Due to this, it is not necessary to check whether or not to limit the utilization of each of the information processing services individually, and accordingly it is possible to shorten the processing time period for liming the usage of the information processing services.

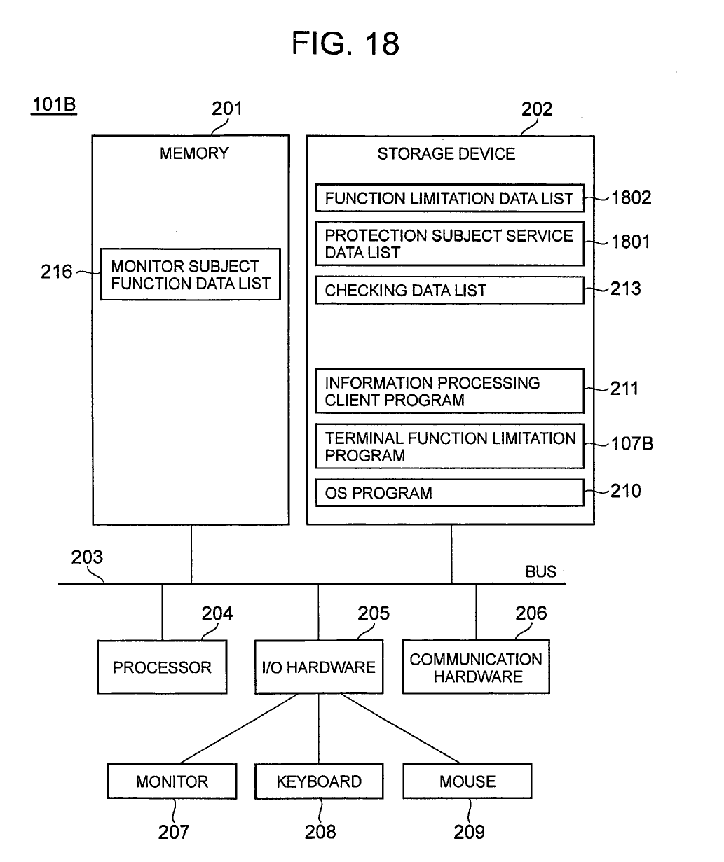

Next, a third embodiment of the present invention will be explained using FIGS. 18 through 21. This third embodiment of the present invention is one in which a method is performed of, when a plurality of information processing service which are subjects of protection are being utilized by a terminal, suppressing the influence due to the process for one of these information processing services upon the others which are being utilized, and of imposing functional limitation upon printing and screen capture and so on; and a method is also implemented of registering an information processing services as a subject of protection. It should be understood that to elements which are the same as ones of the embodiments previously described above, the same reference symbols are affixed, and detailed explanation thereof is omitted.

Since the overall structure of this information processing limitation system 100B according to the third embodiment of the present invention is the same as the overall structure of the information processing limitation system 100 according to the first embodiment of the present invention as shown in FIG. 1, it is not shown in the figures, and explanation thereof will be omitted. An outstanding point of difference between this third embodiment and the first embodiment is that it is arranged to use a terminal 101B instead of the terminal 101, and a management computer 102B instead of the management computer 102.

FIG. 18 is a structural diagram for explanation of the structure of a terminal 101B in a third embodiment of the present invention. The difference from the terminal 101 in the first embodiment shown in FIG. 2, is that a protection subject service data list 1801 (information about subjects of protection) and a function limitation data list 1802 (information about functions which are the subjects of limitation) are stored as data in the storage device 202 of this terminal 101B. It should be understood that the terminal function limitation program 107B which is stored in the storage device 202 of the terminal 101B has the same function as that of the terminal function limitation program 107 of the first embodiment shown in FIG. 2.

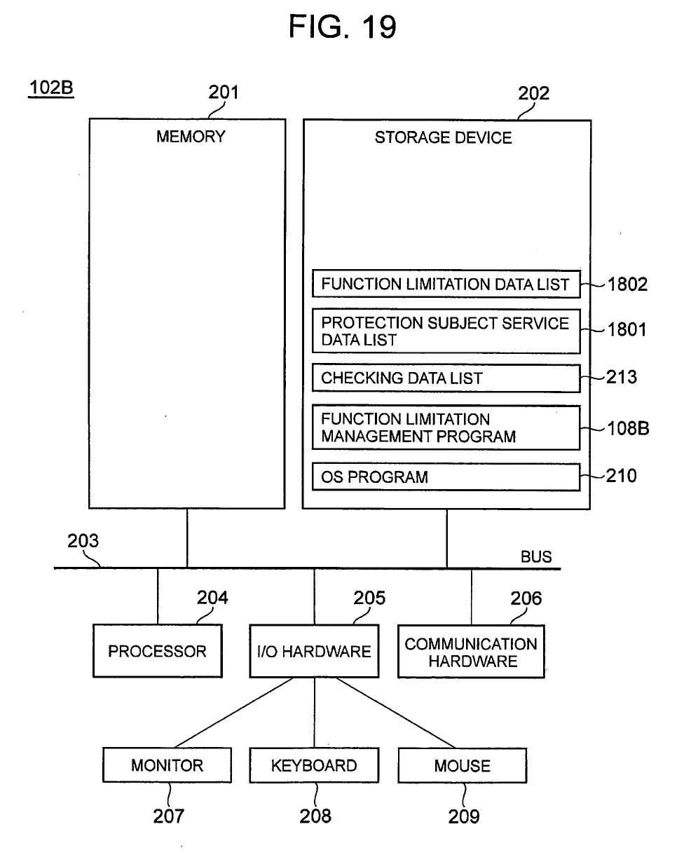

FIG. 19 is a structural diagram for explanation of the structure of a management computer 102B in a third embodiment of the present invention. The difference from the management computer 102 in the first embodiment shown in FIG. 3, is that the protection subject service data list 1801 and the function limitation data list 1802 are also stored as data in the storage device 202 of this management computer 102B. It should be understood that the function limitation management program 108B which is stored in the storage device 202 of the terminal 102B has the same function as that of the function limitation management program 108 of the first embodiment shown in FIG. 3.

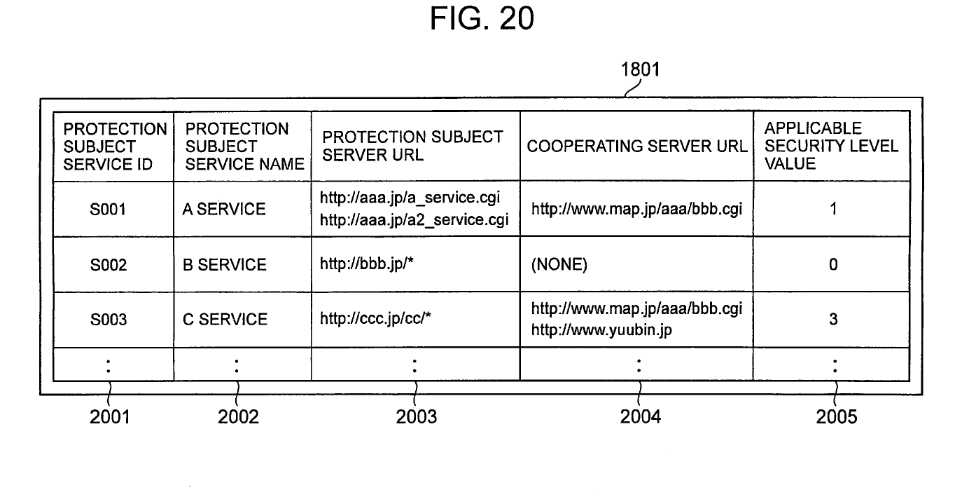

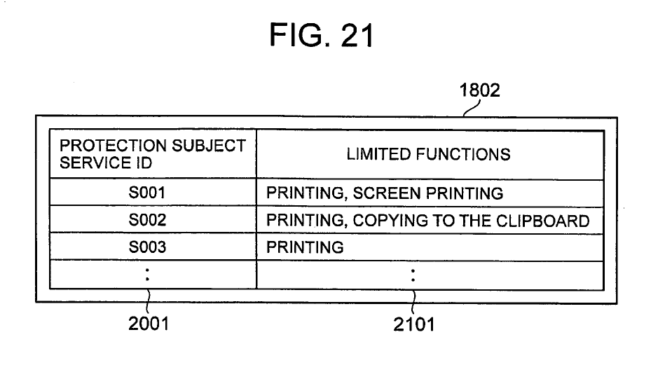

Next, the data structures in this information processing limitation system according to the third embodiment of the present invention will be explained with reference to FIGS. 20 and 21.

FIG. 20 is a figure for explanation of the structure of the protection subject service data list shown in FIG. 18. As shown in FIG. 20, the protection subject service data list 1801 has some fields which are a protection subject service ID 2001, a protection subject service name 2002, a protection subject server URL (Uniform Resource Locator) 2003, a cooperating server URL 2004, and an applicable security level value 2005.

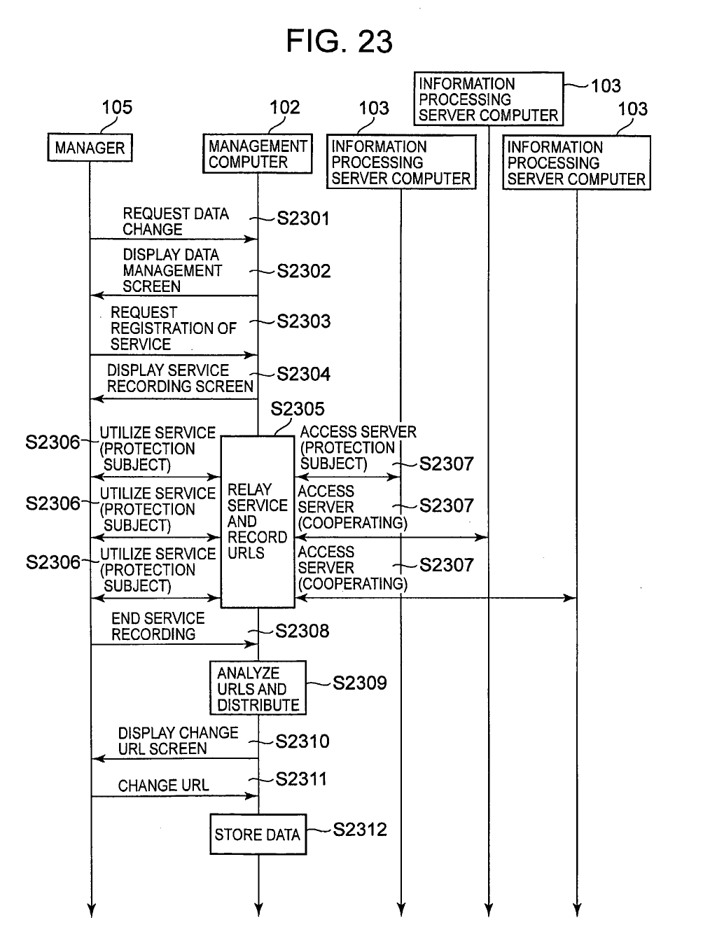

The protection subject service ID 2001 is a field in which is held a unique identifier in this information processing limitation system 100B for an information processing service which is a subject of protection. The protection subject service name 2002 is a field in which is held a title of a function which corresponds to the protection subject service ID 2001. The protection subject server URL 2003 is a field in which is held the URL on a server at which the information processing service which is the subject for protection is located. The cooperating server URL 2004 is a field in which is held the URL of a server (termed a “cooperating server”) which cooperates when the information processing service which is the subject of protection is performing its service. And the applicable security level value 2005 is a field in which is held a security level of the terminal 101B at which the function which corresponds to the protection subject service ID 2001 can be utilized without limitation of utilization. The manager 105 configures the details of this protection subject service data list 1801 in advance, in accordance with organizational objectives. And, when the manager needs to perform addition to the details of the protection subject service list 1801, he is able to utilize the functions provided by the data change interface part 406 (refer to FIG. 4) of the function limitation management program 108B, according to the flow chart shown in FIG. 23.

It should be understood that a cooperating server is a server which stores data which is required for the user to obtain the information processing service which is provided from the server which is the subject for protection. When receiving an information processing service which is a subject for protection from one information processing service computer with an information processing client program 211, sometimes it happens that the information processing client program 211 is commanded by that one information processing service computer 103 to access another information processing service computer 103 (the so-called “cooperating server”). For example, when providing an information processing service for displaying image data which is a subject for protection, if only a link to a cooperating server is registered upon the protection subject server which provides that information processing service, while the image data itself is held upon the cooperating server, a command is issued to access the cooperating server. The URL which is the subject of this access command is held in the cooperating server URL 2004. By “cooperation” by the cooperating server is meant a situation in which, from the information processing service computer 103 which implements this information processing service which is the subject for protection, access commands are received for implementing this information processing service. Fundamentally, the information processing service which is implemented by the cooperating server itself is not a subject for protection. In this cooperating server URL 2004, there also may be registered the URL of a server which cooperate with the cooperating server cooperating with the protection subject server (and is not cooperating with the protection subject server).

FIG. 21 is a figure for explanation of the structure of the function limitation data list 1802 shown in FIG. 18. As shown in FIG. 21, the function limitation data list 1802 has some fields which are a protection subject service ID 2001 (which is the same as described above) and a limited function 2101. The limited function 2101 is a field in which is held a list of the functions which are to be limited during the utilization of the information processing service which corresponds to the protection subject service ID in the 2001. Fundamentally, the function which is stored in the limited function 2101 is a function for which there is a possibility that information leakage might occur; but, in more concrete terms, it is a function with which information is stored either temporarily or semipermanently in a storage device (the memory 201, the storage device 202, or the like), and then this information is read out by operation from externally. The manager 105 configures the values in this function limitation data list 1802 in accordance with organizational objectives.

With this information processing limitation system 100B having the structure described above, when a user 104 in the organization utilizes the information processing service using his terminal 101B, the utilization of the information processing service is limited according to the state of the terminal 101B. During startup, operation, and stopping of the terminal, the terminal 101B gets the newest checking data list 213, the protection subject service data list 1801, and the function limitation data list 1802 referred to by the terminal function limitation program 107B during limitation of the information processing service from the management computer 102B.

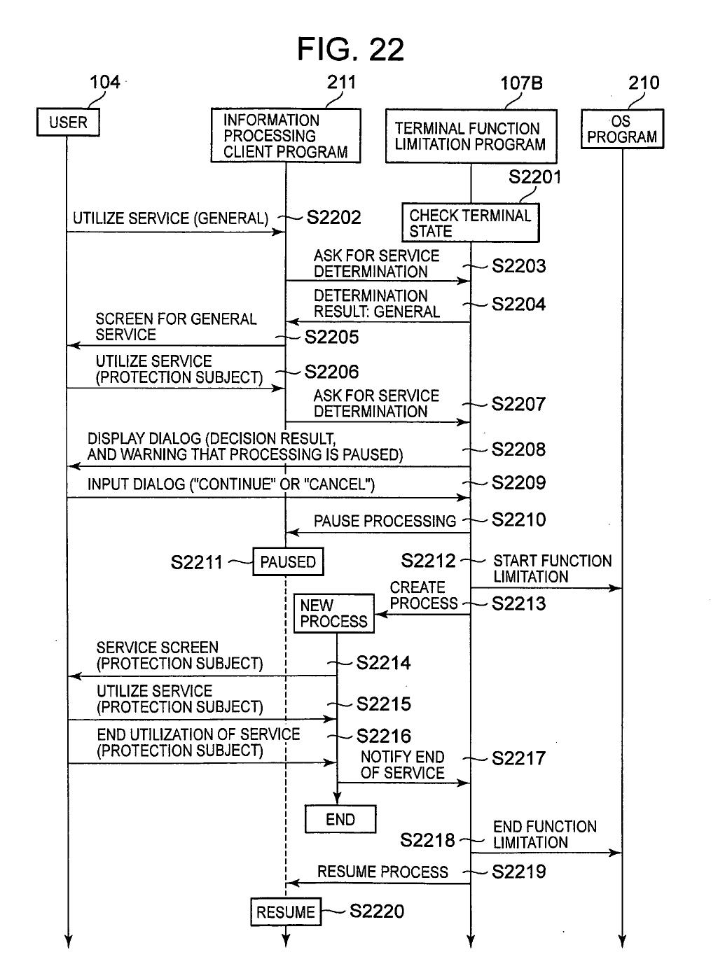

Next, the operation of this information processing limitation system according to the third embodiment of the present invention will be explained using FIGS. 22 and 23.

FIG. 22 is a timing chart for explanation of the operation of this third embodiment of the present invention during the utilization of an information processing service which is a subject for protection, while the user is utilizing a general information processing service which is not itself a subject for protection.

First, the terminal function limitation program 107B of the terminal 101B periodically checks the terminal state while the terminal 101B is being started and while it is running (S2201), and determines its most recent security level. And, when the user 104 makes a request to the information processing client program 211 to utilize an information processing service (which it will be supposed is a general type service) (S2202), then the information processing client program 211 sends to the terminal function limitation program 107B the URL of this information processing service which the user has requested to utilize, and asks that program 107B to make a decision as to whether or not the requested service is a subject of protection (a service determination request) (S2203). The terminal function limitation program 107B checks whether or not the URL which has been sent is in any protection subject server URL 2003 of the protection subject service list 1801, and, if it is in not in any one of those fields, returns a determination result that this service is not a subject of protection (S2204). If it has been determined that this information processing service is a general service, the information processing client program 211 provides the functions of this information processing service to the user just as they are without modification (for example, provides a service screen for general service) (S2205).

When, thereafter, the user asks to utilize a new service (which it will be supposed is a service which is a subject of protection) (S2206), in a similar manner to the S2203, the information processing client program 211 asks the terminal function limitation program 107B to make a decision as to whether or not the requested service is a subject of protection (a service determination request) (S2207). And the terminal function limitation program 107B checks whether or not the URL which has been sent is in any protection subject server URL 2003 of the protection subject service list 1801, and, if it is in one of those fields, considers it to be a service which is a subject of protection, and transmits a dialog display to the user to the effect that this service is a subject of protection, and that the current general information processing service utilization process is paused (S2208). It should be understood that, when the service process for information processing is to be paused, the method which is used is, for example, one of inserting, into the script that implements this service process, a script code to make this service process ineffective.

The user replies by inputting a dialog as to whether the service which is the subject of protection should be continued or cancelled (S2209). If “cancel” is selected, the terminal function limitation program 107B commands the information processing client program 211 not to continue with the utilization of the new information processing service, and accordingly the information processing client program 211 refuses the service utilization request of the S2206.

If the user has selected “continue” in the S2209, the terminal function limitation program 107B issues a pause command (for process pausing) for all of the processes of the information processing client program 211 (S2210), and these processes pause (S2211). Moreover, the terminal function limitation program 107B requests the OS program 210 to start function limitation as described in the function limitation data list 1802 for the service which corresponds to the utilization request and which is the subject of protection (S2212). And the terminal function limitation program 107B starts a new process of the information processing client program 211, and transmits the URL of the information processing service which the user 104 has requested to utilize to the new process (the novel process) (S2213).

This novel process of the information processing client program 211 accesses the URL of the information processing service which the user 104 has requested to utilize, and provides a (subject of protection) service screen to the user 104 (S2214). And the user 104 uses this service screen which is provided for the novel process to utilize the service which is the subject of protection (S2215). At this time, the new process forbids access to any URL apart from the protection subject server URL and the URL described in its cooperating server URL. Moreover, the starting of any new information processing service is prevented. It should be understood that the difference between the case of the cooperating server URL and the case of the protection subject server URL is that, even if the information processing client program 211 accesses that URL, transition does not take place to the protection mode in which the above pausing (of the S2211) is performed. On the other hand, during the protection mode, it is possible for the protection subject server URL and the corresponding server URL which corresponds thereto to be accessed by the information processing client program 2211.

Thereafter, when the user terminates his utilization of the (protection subject) service (S2216), the new process notifies the terminal function limitation program 107B that service utilization has ended (S2217), and then the new process terminates. When the end of utilization of the service which was the subject of protection is confirmed by notification of the end of service by the new process and by detection of the end of the new process, then, after having requested the OS program 210 to terminate the function limitation which was started in the S2212 (S2218), the terminal function limitation program 107B requests the process of the general information processing service which was paused in the S2211 to resume (S2219). It should be understood that, as a method of resuming this service process for information processing, there is, for example, the method of invalidating the script code which was inserted into the script for implementation of this service process and which makes this service process ineffective, provided that the condition that it is possible to check the end of utilization of the service which was the subject for protection is satisfied.

Finally, the information processing client program 211 receives a request from the terminal function limitation program 107B, and resumes the process of the general information processing service which was paused (S2220). It should be understood that, in FIG. 22 and in this explanation, “processes” are programs which receive allocation of resources such as memory regions or the like from the OS program 210, and for which processing is executed. Moreover, in a terminal which uses an OS program 210 which can manage multi-threading, parts of the processes shown in FIG. 2 and explained herein may also be replaced by threads.

FIG. 23 is a timing chart for explanation of the operation when, in this third embodiment of the present invention, the manager 105 adds to the above protection subject service data list 1801 a new service which is to be a subject for protection.

When (on the outside) the manager 105 issues a data change request to the function limitation management program 108B of the management computer 102 (S2301), the management computer 102 provides a data management screen to the manager 105 (S2302). When, upon this data management screen, the manager 105 issues a request for a service to be added as a subject of protection (i.e., a service registration request) (S2303), the management computer 102 provides a screen (a service recording screen) for registering this service as being a subject for protection (S2304).

The manager 105 inputs upon this service recording screen the URL of the service which he desires newly to record as being a subject for protection, and briefly utilizes this information processing service (S2306). At this time, the management computer 102 accesses the information processing server computer 103, and, along with sending the input information to the information processing service which is inputted by the manager 105 to the information processing server computer 103 (S2307), also returns to the manager 105 information such as a screen or the like which is returned by the information processing server computer 103. The transmission and reception of this kind of information is performed to and fro between the manager 105, the management computer 102, and the information processing server computer 103 (service relaying). It should be understood that, of course, the protection subject server is also included in the information processing server computer 103 which the management computer 102 accesses; and the cooperating servers which cooperate with this protection subject server are also included. Moreover, the management computer 102 records all of the URLS (predetermined information: information which specifies the whereabouts of that information processing service) which have been accessed during the utilization of the service (S2305).

The manager 105 briefly utilizes the information processing service, and, when the recording of the service which he has utilized is completed, he notifies the management computer 102 to this effect (S2308). And the management computer 102 analyzes, from the URLs which have been recorded during utilization of the service by the manager 105, the URL which is mentioned in the protection subject server URL 2003 and the URLs which are described in the cooperating server URL 2004, and determines which of these URLs should be distributed into which of the fields 2003 and 2004 (S2309). Here, a list of the URLs which have been determined is displayed to the manager 105 as a URL change screen (S2310), and a URL change command is received from the manager 105 (S2311). At this time input is received from the manager 105 for registering the protection subject service name and the applicable security level value field into the protection subject service name 2002 and the applicable security level value 2005, respectively.

Finally, this data is added to the protection subject service data list 1801 as a new service to be protected, and this list is stored (S2312). It should be understood that, upon this addition, a protection subject service ID 2001 corresponding to this new service which is to be protected may, for example, be automatically created in the protection subject service data list 1801.

Since, in this manner, according to this embodiment, when the user is utilizing the information processing service which is a subject for protection and which is mentioned in the protection subject service data list 1801, the process of the information processing client program which is being executed is paused, and moreover functions such as printing and the like are limited, accordingly, during the utilization of the information processing service which is a subject for protection, it is possible to prevent information held by this information processing service which is a subject for protection from being improperly copied to some other process or to memory, to a medium, or the like. Moreover, it is possible for the manager to create a list of services which are to be the subjects of protection by actually utilizing these protection subject services, so that it is possible to shorten the time period which is required for creating the list of these services which are to be subjects for protection, as compared to the case of employing a per se known URL filtering technique (a technique of specifying the URLs to which access is to be prohibited).

It should be understood that the structure of the present invention should not be considered as being limited only to the disclosed embodiments; various changes thereto would be acceptable, provided that the gist of the present invention is not departed from.

For example although, in the third embodiment, when the service which is the subject of protection was being utilized, control was exerted so as to pause the utilization of the general service which was being utilized, it would also be acceptable, instead of pausing in this manner, to stop (i.e. to end) the utilization of the general service. In concrete terms, in order to stop the service process for the information processing, for example, a script code may be inserted into the script which implements this service process, which terminates this service process. Moreover, while there is fundamentally no particular requirement to perform function limitation by the OS program when stopping the utilization of a general service, it would also be acceptable to perform such function limitation in order to strengthen the protection for the protection subject service, or in order to prevent improper operation from an ill-intentioned user before it even happens.

Apart from the above, various appropriate changes may be made to the concrete structure of the hardware, the software, the flow charts and so on, provided that the essence of the present invention is not departed from.

1. An information processing system, comprising:
a server computer which provides an information processing service; and
a computer which is coupled to the server computer, and which utilizes the information processing service;
wherein, the computer limits the utilization of the information processing service on the basis of a security state which is required for the utilization of the information processing service.

2. An information processing system according to claim 1,
wherein, the computer limits the utilization of the information processing service on the basis of a group of the information processing services for which simultaneous utilization is limited.

3. An information processing system according to claim 2,
wherein the server computer limits connection of the computer,
wherein the computer cancels connection limitation by the server computer, and wherein, the computer limits the utilization of the information processing service on the basis of the result of the cancellation of the connection limitation by the server computer.

4. An information processing system according to claim 1,
wherein, when the computer executes an information processing, the computer limits the execution of the information processing on the basis of a security state which is required for the execution of the information processing.

5. An information processing system according to claim 4,
wherein the computer is capable of executing a plurality of the information processing tasks simultaneously, and
wherein, when the computer executes the information processing, the computer limits the execution of the information processing, on the basis of a group of the information processing tasks whose execution is limited simultaneously.

6. An information processing system according to claim 4,
wherein, when the computer utilizes the information service, the computer limits the execution of the information processing on the basis of a group including the information processing service and the information processing.

7. An information processing system according to claim 4,
wherein, when the computer executes the information processing, the computer limits the utilization of the information processing service on the basis of a group including the information processing service and the information processing.

8. An information processing apparatus utilizing an information processing service provided by a server computer, comprising:
a communication hardware coupled to the server computer; and,
a processor limiting the utilization of the information processing service via the communication hardware on the basis of a security state which is required for the utilization of the information processing service according to the utilization of information processing service.

9. An information processing apparatus according to claim 8,
wherein the communication hardware is coupled to a plurality of the server computers, and
wherein, during the utilization of the information processing service, the processor limits the utilization of the information processing service on the basis of a group of the information processing services for which simultaneous utilization is limited.

10. An information processing apparatus according to claim 9,
wherein the processor cancels connection limitation by the server computer, and wherein, during the utilization of the information processing service, the processor limits the utilization of the information processing service based on the cancellation of the connection limitation.

11. An information processing apparatus according to claim 8,
wherein the processor executes an information processing, and
wherein, during the execution of the information processing, the processor limits the execution of the information processing, based on a security state which is required for the execution of the information processing.

12. An information processing apparatus according to claim 8, comprising:
a storage device having protection subject information and limitation subject function information,
wherein the protection subject information includes the security state and a information processing service which is to be a subject of protection against information leakage are held in mutual correspondence,
wherein the limitation subject function information includes the information processing service which is to be the subject of protection and a function executed by the computer, for which there is a possibility of information leakage occurring, are held in mutual correspondence,
wherein, in case that the computer is already utilizing an information processing service, when the utilization of the information processing service which is to be a subject of protection starts, and if the security state which is required for utilization of the information processing service which is to be a subject of protection is satisfied, along with pausing the process of the information processing service which is already being utilized, and the limitation part of the computer limits the function which starts the utilization and corresponds to the information processing service which is to be a subject of protection by referring to the protection subject information and limitation subject information, and
wherein, when the utilization of the information processing service which is to be a subject of protection ends, along with resuming the process of the information processing service which was paused, the limitation part of the computer terminates the limitation of the function.

13. An information processing system according to claim 1,
wherein the computer stores protection subject information, in which the security state and the information processing service which is to be a subject of protection against information leakage are held in mutual correspondence,
wherein the computer stores limitation subject function information, in which the information processing service which is to be the subject of protection and a function executed by the computer, for which there is a possibility of information leakage occurring, are held in mutual correspondence,
wherein, in case that the computer is already utilizing an information processing service, when the utilization of the information processing service which is to be a subject of protection starts, the computer refers to the protection subject information, and
wherein, if the security state which is required for utilization of the information processing service which is to be a subject of protection is satisfied, the computer stops the process of the information processing service which is already being utilized.

14. An information processing system according to claim 1, further comprising:
a management computer which is coupled to the server computer, and which manages the utilization of the information processing service by the computer, wherein the computer stores protection subject information, in which the security state and the information processing service which is to be a subject of protection against information leakage are held in mutual correspondence,
wherein, when a request for adding an information processing service which is to be a subject of protection is received from an outer, the management computer accesses the server computer, and stores in the computer whereabouts information for the information processing service which is to be utilized, on the basis of the utilization of the information processing service which has been requested to be added from the outer, and
wherein the management computer creates protection subject information on the basis of the whereabouts information for the information processing service which has been utilized, and the security state which has been acquired from the outer, and stores the protection subject information in the storage device.
